(19) United States
(12) Patent Application Publication
(10) Pub. No.: US 2024/0256744 A1
(43) Pub. Date: Aug. 1, 2024

(54) SERVERS, SYSTEMS, AND METHODS FOR FLUID PHASE DETECTION

(71) Applicant: AVEVA Software, LLC, Lake Forest, CA (US)

(72) Inventors: Gang Xu, Irvine, CA (US); Zhenghao Li, Mountain View, CA (US); Nevin Gerek Ince, Copenhagen (DK); Ian Boys, Vista, CA (US)

(21) Appl. No.: 18/426,684

(22) Filed: Jan. 30, 2024

Related U.S. Application Data
(60) Provisional application No. 63/441,990, filed on Jan. 30, 2023.

(51) Int. Cl. G06F 30/28; G06F 113/08

(52) U.S. Cl. CPC G06F 30/28; G06F 2113/08

(57) ABSTRACT

In some embodiments, the disclosure is directed to a system for simulating multiple components and phases for fluid phase detection. In some embodiments, the system is configured to execute fast iterations under given temperature, pressure, and feed, with liquid phases starting from 100% purity of a corresponding key component. In some embodiments, the system is configured to apply a direct substitution method with relaxation damping for iterations at fixed conditions. In some embodiments, the system is configured to draw a tangent plane from a suspicious phase composition and execute a tangent plane distance analysis at a potentially missed physical phase by estimating 95% to 99.9999% purity of a possible liquid key component. In some embodiments, the system is configured to automatically correct the order of key components for simulations, based on analyses such as tangent plane distance analysis, immiscibility checks, and the exclusion of Henry components.

### REFERENCE TO RELATED APPLICATION

This application claims the benefit of priority from U.S. Provisional Application No. 63/441,990, filed Jan. 30, 2023, entitled “SERVERS, SYSTEMS, AND METHODS FOR FLUID PHASE DETECTION,” which is incorporated herein by reference in its entirety.

### BACKGROUND

Design and control of processes that include distillation and extraction phase splitting is a difficult task due to thermodynamic instability of liquid mixtures. Current systems are not able to accurately predict when a feed has split into multiple liquid phases, especially in real-time or car real-time.

Therefore, there is a need for a system that can detect certain fluid and particularly liquid phases automatically and efficiently.

### SUMMARY OF THE DISCLOSURE

In some embodiments, the system is configured to execute a fast and robust tangent plane distance analysis based on “near” pure components. In some embodiments, the system is configured to enable a user to select first and second liquid (L1/L2) key pairs from a candidate list obtained from a system-determined near pure component tangent plane distance value and/or molecular weight. In some embodiments, the system is configured to, and/or enable a user to, exclude a component from a liquid key candidate list if the component is defined as Henry component, and/or has lower Gibbs energy value as a vapor. In some embodiments, the system is configured to execute a fast iteration calculation for a given temperature, pressure, and feed. In some embodiments, both liquid phases start from 100% purity of a corresponding key component in the iteration. In some embodiments, if a user provides one liquid key component, then the other liquid key would be decided by an approach described herein. In some embodiments, the system is configured to, and/or enable a user to, identify a library component by molecular weight. In some embodiments, for simulations converged previously using user-defined keys, the system is configured to automatically correct the key order.

In some embodiments, the disclosure is directed to a system for fluid phase detection comprising one or more processors comprising one or more computers and one or more non-transitory computer readable media. In some embodiments, the one or more non-transitory computer readable media including program instructions stored thereon that when executed cause the one or more computers to implement one or more steps. Some embodiments include a step to execute, by the one or more processors, a tangent plane distance analysis based on near pure components. Some embodiments include a step to determine, by the one or more processors, near pure component tangent plane distance values and/or molecular weights. Some embodiments include a step to generate, by the one or more processors, a candidate list obtained from the determined near pure component tangent plane distance values and/or the molecular weights. Some embodiments include a step to enable, via a graphical user interface (GUI), user selection of first liquid and second liquid key pairs from the candidate list. Some embodiments include a step to identify, by the one or more processors, a dominating component in each liquid phase and display the identified dominating components on the GUI.

In some embodiments, the one or more non-transitory computer readable media further include program instructions stored thereon that when executed cause the one or more computers to execute, by the one or more processors, a fast iteration calculation for a given temperature, pressure, and/or feed. In some embodiments, the fast iteration calculation includes both liquid phases starting from 100% purity of a corresponding key component.

In some embodiments, the one or more non-transitory computer readable media further include program instructions stored thereon that when executed cause the one or more computers to execute, by the one or more processors, an immiscibility check. In some embodiments, the immiscibility check is configured to determine if fewer than two components from the candidate list have a negative tangent plane distance value.

Some embodiments include a step to detect, by the one or more processors, a “W” shaped profile in a tangent plane distance value calculation and/or plot indicative of phase separation during the immiscibility check. Some embodiments include a step to exclude, by the one or more processors, a component from the candidate list if the component is defined as a Henry component. Some embodiments include a step to exclude, by the one or more processors, components from the candidate list that have a lower Gibbs energy value in a vapor phase than in a liquid phase.

Some embodiments include a step to execute, by the one or more processors, an automatic correction of a key order for simulations that have previously converged using user-defined keys. Some embodiments include a step to determine, by the one or more processors, a Gibbs free energy value at a feed point for use in the tangent plane distance analysis. In some embodiments, the system is configured to be integrated into a thermodynamic core code.

In some embodiments, if water is present, then the system is configured to select water as the second liquid. Some embodiments include a step to identify, by the one or more processors, a user library component by molecular weight when component identification is not given. Some embodiments include a step to enable, by the one or more processors, a user to provide a component molecular weight via the GUI. Some embodiments include a step to exclude, by the one or more processors, fake solutions. Some embodiments include a step to converge, by the one or more processors, on a solution for simulations that may generate fake solutions due to over-regression. Some embodiments include a step to generate, by the one or more processors, a tangent plane from a suspicious phase composition and execute a tangent plane distance analysis at a potentially missed physical phase to identify a negative tangent plane distance value indicative of a fake solution. Some embodiments are directed to a method of executing the system using one or more steps above.

### DRAWING DESCRIPTION

FIG. 1 shows a non-limiting example of a flowchart representing at least a portion of an algorithm executed by the system.

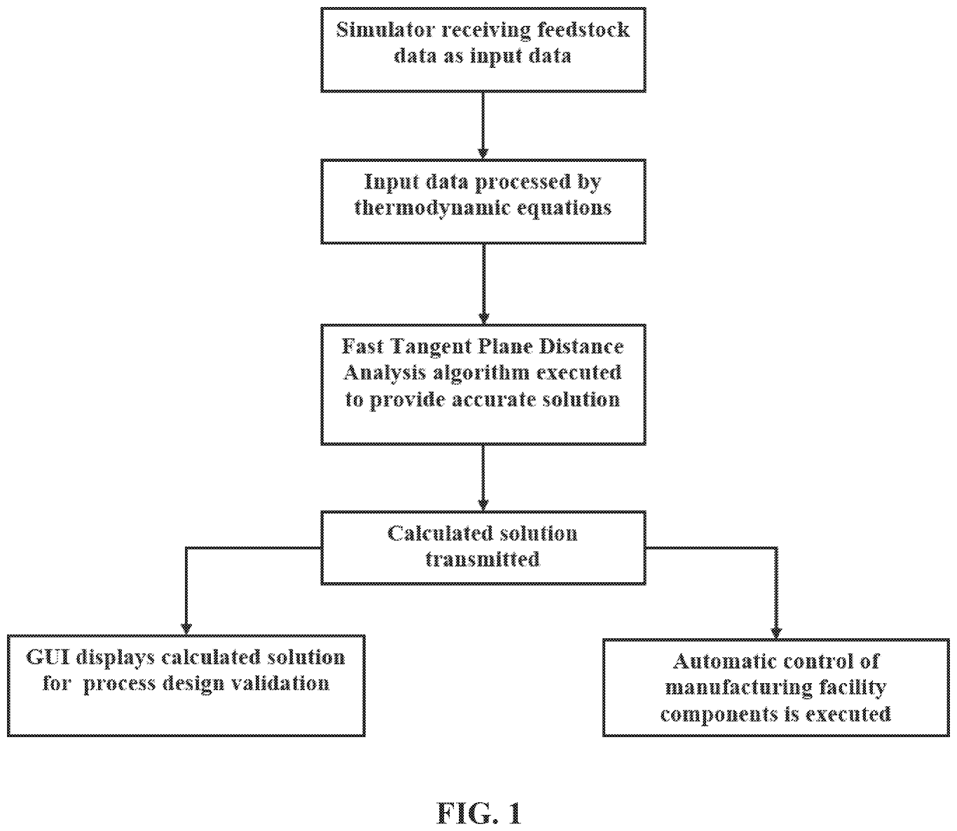

FIG. 2 depicts a non-limiting example application of the system to a refinement process according to some embodiments.

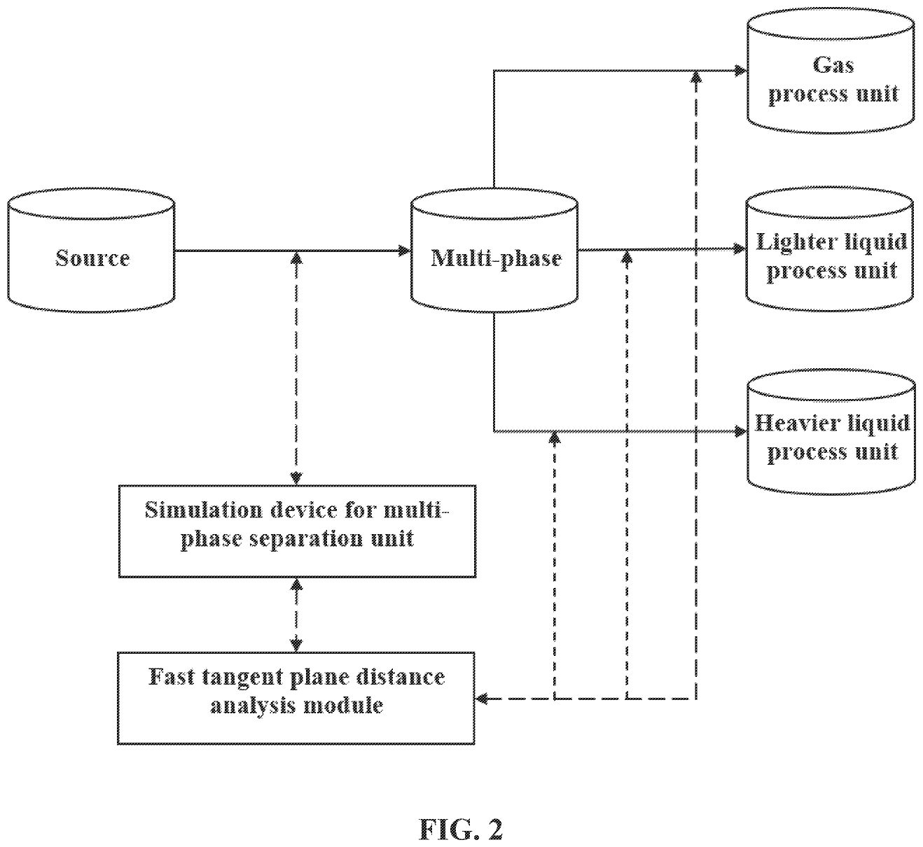

FIG. 3 illustrates a flowchart representing at least a portion of the fast tangent plane distance algorithm described herein according to some embodiments.

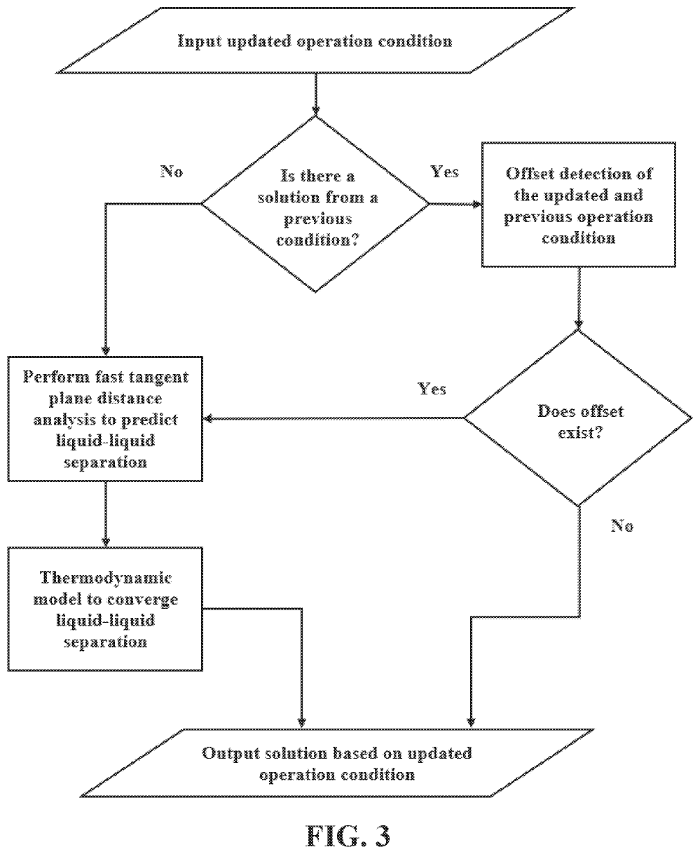

FIG. 4 illustrates a computer system 410 enabling or comprising the systems and methods in accordance with some embodiments.

### DETAILED DESCRIPTION

In some embodiments, open-form vapor-liquid-liquid equilibrium requires reliable and consistent liquid-liquid splits, and liquid swap must be prevented, especially in open-form environment that the equilibrium equation set is a subset of the overall equation set. In some embodiments, to achieve these results, key components must be automatically detected during run-time simulation based on tendency to dominating in certain liquid phase. As a non-limiting example, water would be the second liquid key component if present with other components such as hydrocarbons or special solutes such as aniline, cyclohexane etc., where one of those solutes would be dominating in the organic (or liquid 1) phase. Some embodiments of this disclosure are directed to detecting such a pair of liquid keys (i.e., liquid key components) automatically and efficiently by executing a fast and robust tangent plane distance analysis based on one or more near-pure components.

In some embodiments, the system comprises one or more processors and one or more non-transitory computer readable media. In some embodiments, the one or more non-transitory computer readable media comprises instructions stored thereon that when executed cause the one on or more computers to implement program modules and/or execute one or more steps, such as executing a graphical user interface and/or a simulation. In some embodiments, a method step may comprise providing one or more computers comprising one or more processors and one or more non-transitory computer storage media for implementing the one or more steps.

In some embodiments, the system includes a graphical user interface (GUI) configured to display one or more system platforms. In some embodiments, a system platform includes a simulation platform. In some embodiments, the simulation platform is configured to simulate one or more processes in a manufacturing facility. In some embodiments, the simulation includes various unit operations such as reactors, separators, heat exchangers, pumps, and distillation columns. In some embodiments, one or more simulated processes include a chemical plant and a refinery plant.

In some embodiments, the system includes a thermodynamic core code. In some embodiments, the thermodynamic core code includes mathematical models and/or state equations that describe the thermodynamic properties and behavior of various substances under different conditions. In some embodiments, the properties include one or more of pressure, temperature, volume, enthalpy, entropy, and Gibbs free energy, as non-limiting examples. In some embodiments, the thermodynamic core code can be used to predict phenomena that include phase behavior, reaction equilibria, and/or transport properties.

In some embodiments, the simulation platform is configured to determine a vapor-liquid-liquid equilibrium. Vapor-Liquid-Liquid Equilibrium (VLLE) is a state where three phases (two liquid phases and one vapor phase) coexist in equilibrium. Determining the VLLE involves a large number of variables and requires simultaneously solving nonlinear equations. In some embodiments, the simulation platform is configured to use the thermodynamic core code, which contains mathematical models and equations, to calculate the equilibrium state. In some embodiments, the system is configured to enable a user to input the properties of the components in the mixture (temperature, pressure, concentration, etc.) which allows the system to predict the composition and properties of each phase at equilibrium as described further herein.

In some embodiments, the simulation platform is configured to determine liquid phases consistency. In some embodiments, the simulation platform is configured to track and predict phase behavior based on the thermodynamic models in the thermodynamic core code. In some embodiments, In some embodiments, the system is configured to consistently determine the liquid phases by analyzing the properties of the components (such as temperature, pressure, and concentration) and using the properties to calculate the phase boundaries. In some embodiments, the system is configured to control the physical process such that the physical process operates within defined parameters and/or avoids undesirable phase changes that could disrupt the process.

In some embodiments, the simulation platform is configured to prevent liquid swapping by automatically detecting the dominating component in each liquid phase in run-time. Liquid swapping refers to a situation where the composition of two liquid phases switches, which can cause problems in the process operation. In some embodiments, the system is configured to prevent liquid swapping by automatically detecting the dominant component in each liquid phase during runtime. In some embodiments, detecting the dominant component in each liquid phase is done by executing a fast and robust tangent plane distance analysis based on near-pure components using the steps described herein. In some embodiments, the system is configured to monitor concentration and/or control the process conditions to prevent one or more components from reaching a level where a phase switch could occur by identifying the dominant component.

In some embodiments, the simulation platform is configured to determine an initial vapor-liquid-liquid equilibrium, where the system is able to perform the determination within milliseconds even on a large number of components. In some embodiments, the GUI configured to enable an operator to specify a mixture of 99.999% purity feed. In some embodiments, the simulation platform is configured to determine an initial vapor-liquid-liquid equilibrium by determining a corresponding tangent plane distance value t by executing equation (1):

$$t = g ( {x}_{i} ) - ( {g}_{ref} + \sum ( {x}_{i} - {z}_{i} ) [ \frac{\partial {g}_{ref}}{\partial {z}_{i}} ] ) \qquad ( 1 )$$

In some embodiments, xᵢ is the vector for the molar fraction for each component with 99.9999% purity for a given component; zᵢ is the feeding vector of molar fraction for each component for the vapor-liquid-liquid equilibrium; and noc stands for number of components. In some embodiments, the system is configured to determine the Gibbs free energy value at the feed g_{ref}, which is considered the reference point and expressed as:

$${g}_{ref} = {\sum }_{i = 0}^{noc - 1} {z}_{i} ( ln {z}_{i} + ln {φ}_{i} ( T , P , {z}_{i} ) ) \qquad ( 2 )$$

In some embodiments, the system is configured to determine g(xᵢ). In some embodiments, g(xᵢ) is expressed as:

$$g ( {x}_{i} ) = {\sum }_{i = 0}^{noc - 1} {x}_{i} ( ln {x}_{i} + ln {φ}_{i} ( T , P , {x}_{i} ) ) \qquad ( 3 )$$

In some embodiments, the 99.9999% purity of each component results in a candidate list of which the value of t from equation (1) are the lowest and indicates that such candidate would have tendency to dominate in a liquid phase. Table 1 shows a non-limiting example candidate list output by the system according to some embodiments.

TABLE 1
Example candidate list

| Component | Purity | Value of ‘t’ |
|---|---|---|
| A | 99.9999% | 0.05 |
| B | 99.9999% | 0.07 |
| C | 99.9999% | 0.04 |
| D | 99.9999% | 0.06 |

In this simplified example, ‘A’, ‘B’, ‘C’, and ‘D’ are the components in the mixture, where each component is 99.9999% pure. In some embodiments, the Value of ‘t’ column represents the tendency of that component to dominate in a liquid phase, as calculated using equation (1). In some embodiments, based on the value of ‘t’, the system is configured to identify which component(s) are most likely to dominate in the liquid phase. In this case, component ‘C’ has the lowest value of ‘t’, so it would be identified as the component most likely to dominate.

In some embodiments, the GUI is configured to enable a user to select a first liquid and a second liquid a key pair. When determining the second liquid, a step includes determining if water is present in the mixture. Water, known as the “universal solvent,” can dissolve more substances than any other liquid, which is a property used in processes involving dissolution, extraction, or reactions in solution. Water is a highly polar molecule, which means water interacts differently with various substances compared to nonpolar solvents. These different interactions can affect the distribution of substances in a mixture and the rates of chemical reactions according to some embodiments. In some embodiments, the system is configured to use water's specific temperatures for phase changes (boiling, freezing, etc.) as reference points, as water's presence can significantly influence the temperature and pressure conditions of a process. In some embodiments, if water is present, then water would always be selected as the second liquid. In some embodiments, the system is configured to automatically choose water as the second liquid based on an analysis of the simulation platform inputs.

In some embodiments, the system is configured to select the first liquid based on one or more criteria. In some embodiments, the criteria include the lowest value of below pairing tangent plane distance function, represented by equation (4):

$${t}_{i} = g ( {x}_{i} = {z}_{i} , {x}_{j} = 0 ) - ( {g}_{ref} + \sum ( {x}_{i} - {z}_{i} ) [ \frac{\partial {g}_{ref}}{\partial {z}_{i}} ] ) \qquad ( 4 )$$

Thus, for all other component j (not i or water), x_j=0. In some embodiments, the first liquid includes the index i that the value of ti is the largest, indicating that component i is unlikely to be present in one liquid phase with water.

In some embodiments, if water is not present, or other special component such as hydrogen fluoride, ammonia, are not present, then the system is configured to, and/or enable a user to, select a component in the candidate list that has the largest molecular weight as the second liquid, and/or configured to, and/or enable the user to, select the second largest molecular weight component as the first liquid.

In some embodiments, the system is configured to execute an immiscibility check if fewer than 2 components have a negative value from equation (1). In some embodiments, a negative value from equation (1) guarantees a reliable liquid key component. In some embodiments, if fewer than 2 components have a negative value from equation (1), then an immiscibility check is executed with pairs within the candidate list. In some embodiments, the system is configured to perform the immiscibility check by sweeping one of the components from near zero to near pure condition, and the other component reversed to detect a “W” shape profile of the equation (1) value. In some embodiments, in run-time, the system is configured to generate a result that an immiscibility exists when a second lower point is detected, where the second lower point means a shape of “W” is identified without sweeping certain component xⁱ entirely from 0 to 1.

In some embodiments, the system is configured to exclude a liquid component from the liquid key candidate list if the liquid component is defined as a Henry component and/or has a lower vapor phase 1; value than other components. In some embodiments, a Henry component is excluded from the liquid key candidate list because of the Henry component's behavior in mixtures. Henry's Law is a gas law that states that the amount of dissolved gas in a liquid is proportional to its partial pressure above the liquid, which means a Henry component, or a component that obeys Henry's Law, is likely to have a significant presence in the vapor phase when its partial pressure is high. When the system is trying to identify components that are likely to be present in the liquid phase, the Henry component might not be a good candidate. This is because Henry components tend to escape into the vapor phase, reducing their concentration in the liquid phase. In some embodiments, a Henry component is a component that is configured to only show in the vapor phase: such component should be excluded from liquid key candidate according to some embodiments. In some embodiments, if user marks a certain component as a Henry component, then the system is configured to exclude the certain component as liquid key candidate.

In some embodiments, the system is configured to accept input parameters for temperature, pressure, and feed rate, which may come from a user and/or one or more sensors. In some embodiments, the system is configured to execute a fast iteration under given temperature, pressure and feed, with both liquid phases starting from 100% purity of corresponding key component. In some embodiments, the system is configured to apply a direct substitution with relaxed dumping to iterate a fixed temperature, fixed pressure, and/or fixed feed flowrate. In some embodiments, both liquid phases start with 100% purity of the corresponding key component. In some embodiments, the identical matrix (diagonal elements are all 1.0, and off-diagonal elements are all 0.0) are assumed to be the Jacobian matrix to avoid a matrix calculation. In some embodiments, a relaxation damping is applied to control the convergence. In some embodiments, relaxation damping includes scaling the change from one iteration to the next by a factor less than 1 to prevent the solution from oscillating or overshooting. In some embodiments, the system is configured to generate a GUI enabling a user to input a selection choice of which approach to apply. In some embodiments, each selection choice GUI is configured to achieve a fast convergence without a complicated derivative calculation.

In some embodiments, if a user provided one liquid key component, then the other liquid key would be decided by one or more above approaches. As a non-limiting example, if user, via the GUI, provided one component as liquid key for either the first liquid or the second liquid, then the system is configured to decide the other liquid key by one or more of tangent plane distance analysis, selecting key pairs from the candidate list, an immiscibility check, and excluding a Henry component. In some embodiments, water or special components are not limited to be the second liquid key.

In some embodiments, the system is configured to identify a user library component by molecular weight. In some embodiments, the system includes library that contains a list of chemical components along with their properties, including molecular weight. In some embodiments, the system is configured to enable a user to provide the molecular weight of the component they are trying to identify. In some embodiments, the system is configured to scan through the library and find the component(s) that match the input molecular weight. Therefore, for a user provided component data/property library where component identification is not given, the system is configured to identify and/or provide the component using an accurate component molecular weight as an input.

In some embodiments, the system is configured to automatically correct a key order for simulation converged previously using user defined keys. In some embodiments, “key order” refers to the order or sequence in which components (keys) are considered or processed in the simulation. In a multicomponent system, the order in which components are considered can influence the outcome of the simulation, especially in iterative procedures. In some embodiments, correcting the key order includes adjusting the sequence based on new information or requirements. For example, if the system has converged on a solution using user-provided keys, but now needs to operate without user-provided keys, it might adjust the key order based on which component dominates in each liquid phase. In some embodiments, where a solution might be obtained by user provided keys, and now requires no user provided keys, the system is configured to automatically correct the key order by checking the dominating component in each liquid phase by executing one or more of tangent plane distance analysis, selecting key pairs from the candidate list, an immiscibility check, and excluding a Henry component as describe above.

In some embodiments, the system is configured to exclude a fake solution and converge on a physical solution for simulations involving model parameters which generate a fake solution. In some embodiments, there are thermodynamic models that the modeling parameters might be obtained with over-regression. In some embodiments, over-regression could lead to a mathematic phase equilibrium (fake) solution. In some embodiments, the system is configured to identify such a fake solution. In some embodiments, the system is configured to draw a tangent plane from a suspicious phase composition and execute a tangent plane distance analysis at a potentially missed physical phase by estimating 95% to 99.9999% purity of a possible liquid key component. In some embodiments, if a negative tangent plane distance value is identified, then the system is configured to determine the solution as fake. In some embodiments, once a fake solution is detected, the potential missed liquid phase which was detected with 95% to 99.9999% purity is then applied by the system as new initial value to restart direct substitution. In some embodiments, a direct substitution includes excluding a Henry component as described above.

In some embodiments, the system is configured to be integrated into a (AVEVA®) thermodynamic core code. In some embodiments, as result, a simulation platform (e.g., AVEVA® Process Simulation (APS), AVEVA® Dynamic Simulation (DYNSIM)) can directly benefit from the integration when the customers who use the simulation platform (e.g., APS and DYNSIM) need to do one or more of product purification, hazard component management (e.g., keeping hazard but useful elements within the production loop without leaking to the environment), and plant safety monitoring, where the simulation platform that uses the system is able to predict events as a digital representation before such events physically happen.

In some embodiments, other non-limiting example platforms where the system is configured for integration include AVEVA PROCESS ENGINEERING (known as PRO/II) and AVEVA PROCESS Optimization (known as ROMeo, Rigorous On-line Modeling and Equation-based Optimization) where each is configured to call the system's thermodynamic core code indirectly, so that users get the benefit of the system described herein. In some embodiments, for AVEVA PROCESS ENGINEERING, as a non-limiting example process design platform, the system is configured to enable process design by implementing the system a user benefits from the accuracy of the liquid-liquid separation results that the system offers. In some embodiments, for AVEVA PROCESS OPTIMIZATION, as a non-limiting example control platform, the system enables (near) real-time control and optimization of a physical manufacturing facility (e.g., plant), and the benefit comes from both accuracy and performance provided by the system.

The following are non-limiting utility examples where the system can be integrated. In some embodiments, the system is useful in chemical, pharmaceutical, and refinery industries, where the purifying processes involve multiple liquids. In some embodiments, the system is useful in processes such as designing a hydrogen fuel cell where water and electrolysis are involved, where the system aids in design, safety, and optimization processes. In some embodiments, the system is useful in wastewater treatment processes to optimize the water and hazard separation during real-time operation. In some embodiments, for liquefied nature gas processing (LNG), the system improves the design, safety, and optimization processes. In some embodiments, in an LNG process water needs to be separated from the nature gas before pipeline and coolant needs to be applied to absorb the heat from the nature gas, shrinking the volume of the gas before pipeline: both need accurate and efficient vapor-liquid-liquid prediction, which the system is configured to provide.

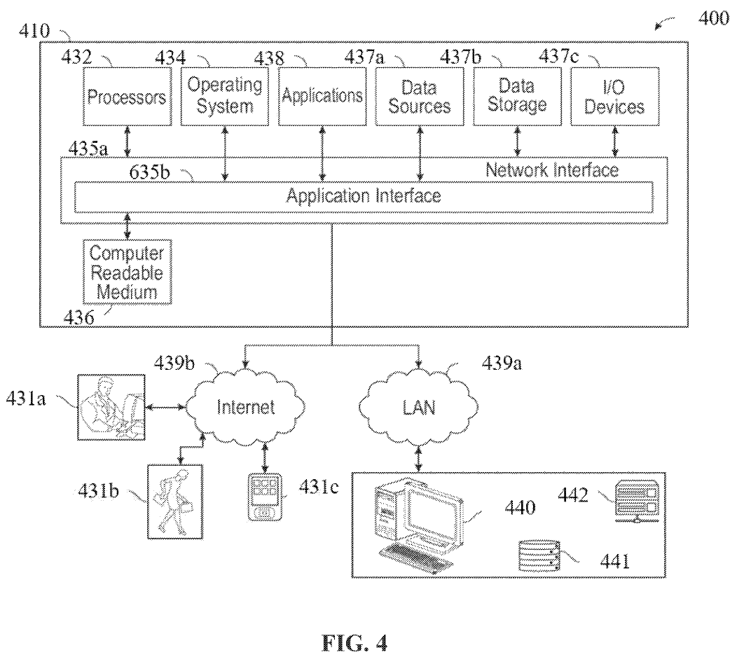

FIG. 4 illustrates a computer system 410 enabling or comprising the systems and methods in accordance with some embodiments. In some embodiments, the computer system 410 can operate and/or process computer-executable code of one or more software modules of the aforementioned system and method. Further, in some embodiments, the computer system 410 can operate and/or display information within one or more graphical user interfaces (e.g., HMIs) integrated with or coupled to the system.

In some embodiments, the computer system 410 can comprise at least one processor 432. In some embodiments, the at least one processor 432 can reside in, or coupled to, one or more conventional server platforms (not shown). In some embodiments, the computer system 410 can include a network interface 435a and an application interface 435b coupled to the least one processor 432 capable of processing at least one operating system 434. Further, in some embodiments, the interfaces 435a, 435b coupled to at least one processor 432 can be configured to process one or more of the software modules (e.g., such as enterprise applications 438). In some embodiments, the software application modules 438 can include server-based software and can operate to host at least one user account and/or at least one client account, and operate to transfer data between one or more of these accounts using the at least one processor 432.

With the above embodiments in mind, it is understood that the system can employ various computer-implemented operations involving data stored in computer systems. Moreover, the above-described databases and models described throughout this disclosure can store analytical models and other data on computer-readable storage media within the computer system 410 and on computer-readable storage media coupled to the computer system 410 according to various embodiments. In addition, in some embodiments, the above-described applications of the system can be stored on computer-readable storage media within the computer system 410 and on computer-readable storage media coupled to the computer system 410. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 410 can comprise at least one computer readable medium 436 coupled to at least one of at least one data source 437a, at least one data storage 437b, and/or at least one input/output 437c. In some embodiments, the computer system 410 can be embodied as computer readable code on a computer readable medium 436. In some embodiments, the computer readable medium 436 can be any data storage that can store data, which can thereafter be read by a computer (such as computer 440). In some embodiments, the computer readable medium 436 can be any physical or material medium that can be used to tangibly store the desired information or data or instructions and which can be accessed by a computer 440 or processor 432. In some embodiments, the computer readable medium 436 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 436 can transmit or carry instructions to a remote computer 440 and/or at least one user 431, including a router, private or public network, or other transmission or channel, both wired and wireless. In some embodiments, the software application modules 438 can be configured to send and receive data from a database (e.g., from a computer readable medium 436 including data sources 437a and data storage 437b that can comprise a database), and data can be received by the software application modules 438 from at least one other source. In some embodiments, at least one of the software application modules 438 can be configured within the computer system 410 to output data to at least one user 431 via at least one graphical user interface rendered on at least one digital display.

In some embodiments, the computer readable medium 436 can be distributed over a conventional computer network via the network interface 435a where the system embodied by the computer readable code can be stored and executed in a distributed fashion. For example, in some embodiments, one or more components of the computer system 410 can be coupled to send and/or receive data through a local area network (“LAN”) 439a and/or an internet coupled network 439b (e.g., such as a wireless internet). In some embodiments, the networks 439a, 439b can include wide area networks (“WAN”), direct connections (e.g., through a universal serial bus port), or other forms of computer-readable media 436, or any combination thereof.

In some embodiments, components of the networks 439a, 439b can include any number of personal computers 440 which include for example desktop computers, and/or laptop computers, or any fixed, generally non-mobile internet appliances coupled through the LAN 439a. For example, some embodiments include one or more of personal computers 440, databases 441, and/or servers 442 coupled through the LAN 439a that can be configured for any type of user including an administrator. Some embodiments can include one or more personal computers 440 coupled through network 439b. In some embodiments, one or more components of the computer system 410 can be coupled to send or receive data through an internet network (e.g., such as network 439b). For example, some embodiments include at least one user 431a, 431b, is coupled wirelessly and accessing one or more software modules of the system including at least one enterprise application 438 via an input and output (“I/O”) 437c. In some embodiments, the computer system 410 can enable at least one user 431a, 431b, to be coupled to access enterprise applications 438 via an I/O 437c through LAN 439a. In some embodiments, the user 431 can comprise a user 431a coupled to the computer system 410 using a desktop computer, and/or laptop computers, or any fixed, generally non-mobile internet appliances coupled through the internet 439b. In some embodiments, the user can comprise a mobile user 431b coupled to the computer system 410. In some embodiments, the user 431b can connect using any mobile computing 431c to wireless coupled to the computer system 410, including, but not limited to, one or more personal digital assistants, at least one cellular phone, at least one mobile phone, at least one smart phone, at least one pager, at least one digital tablets, and/or at least one fixed or mobile internet appliances.

The subject matter described herein are directed to technological improvements to the field of manufacturing facility process control by enabling accurate determination of vapor-liquid-liquid mixtures. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system for fluid phase detection comprising:
one or more processors comprising one or more computers and one or more non-transitory computer readable media, the one or more non-transitory computer readable media including program instructions stored thereon that when executed cause the one or more computers to:
execute, by the one or more processors, a tangent plane distance analysis based on near pure components;
determine, by the one or more processors, near pure component tangent plane distance values and/or molecular weights;
generate, by the one or more processors, a candidate list obtained from the determined near pure component tangent plane distance values and/or the molecular weights;
enable, via a graphical user interface (GUI), user selection of first liquid and second liquid key pairs from the candidate list; and
identify, by the one or more processors, a dominating component in each liquid phase and display the identified dominating components on the GUI.

2. The system of claim 1,
wherein the one or more non-transitory computer readable media further include program instructions stored thereon that when executed cause the one or more computers to:
execute, by the one or more processors, a fast iteration calculation for a given temperature, pressure, and/or feed.

3. The system of claim 2,
wherein the fast iteration calculation includes both liquid phases starting from 100% purity of a corresponding key component.

4. The system of claim 2,
wherein the one or more non-transitory computer readable media further include program instructions stored thereon that when executed cause the one or more computers to:
execute, by the one or more processors, an immiscibility check;
wherein the immiscibility check is configured to determine if fewer than two components from the candidate list have a negative tangent plane distance value.

5. The system of claim 4,
wherein the one or more non-transitory computer readable media further include program instructions stored thereon that when executed cause the one or more computers to:
detect, by the one or more processors, a “W” shaped profile in a tangent plane distance value calculation and/or plot indicative of phase separation during the immiscibility check.

6. The system of claim 1,
wherein the one or more non-transitory computer readable media further include program instructions stored thereon that when executed cause the one or more computers to:
exclude, by the one or more processors, a component from the candidate list if the component is defined as a Henry component.

7. The system of claim 6,
wherein the one or more non-transitory computer readable media further include program instructions stored thereon that when executed cause the one or more computers to:
exclude, by the one or more processors, components from the candidate list that have a lower Gibbs energy value in a vapor phase than in a liquid phase.

8. The system of claim 1,
wherein the one or more non-transitory computer readable media further include program instructions stored thereon that when executed cause the one or more computers to:
execute, by the one or more processors, an automatic correction of a key order for simulations that have previously converged using user-defined keys.

9. The system of claim 8,
wherein the one or more non-transitory computer readable media further include program instructions stored thereon that when executed cause the one or more computers to:
determine, by the one or more processors, a Gibbs free energy value at a feed point for use in the tangent plane distance analysis.

10. The system of claim 1,
wherein the system is configured to be integrated into a thermodynamic core code.

11. The system of claim 10,
wherein if water is present, then the system is configured to select water as the second liquid.

12. The system of claim 1,
wherein the one or more non-transitory computer readable media further include program instructions stored thereon that when executed cause the one or more computers to:
identify, by the one or more processors, a user library component by molecular weight when component identification is not given.

13. The system of claim 12,
wherein the one or more non-transitory computer readable media further include program instructions stored thereon that when executed cause the one or more computers to:
enable, by the one or more processors, a user to provide a component molecular weight via the GUI.

14. The system of claim 1,
wherein the one or more non-transitory computer readable media further include program instructions stored thereon that when executed cause the one or more computers to:
exclude, by the one or more processors, fake solutions; and
converge, by the one or more processors, on a solution for simulations that may generate fake solutions due to over-regression.

15. The system of claim 14,
wherein the one or more non-transitory computer readable media further include program instructions stored thereon that when executed cause the one or more computers to:
generate, by the one or more processors, a tangent plane from a suspicious phase composition and execute a tangent plane distance analysis at a potentially missed physical phase to identify a negative tangent plane distance value indicative of a fake solution.

16. A method for fluid phase detection, comprising steps of:
(a) executing a tangent plane distance analysis based on near pure components to detect fluid phases within a mixture by one or more processors;
(b) determining near pure component tangent plane distance values and/or molecular weights;
(c) generating a candidate list of components likely to dominate in a particular liquid phase based on the determined tangent plane distance values and/or molecular weights;
(d) enabling user selection of first liquid and second liquid key pairs from the candidate list via a graphical user interface (GUI); and
(e) identifying a dominating component in each liquid phase and displaying the identified dominating components on the GUI.

17. The method of claim 16, further comprising a step of:
executing a fast iteration calculation for a given temperature, pressure, and feed.

18. The method of claim 17, further comprising a step of:
executing an immiscibility check if fewer than two components from the candidate list have a negative tangent plane distance value.

19. The method of claim 18, further comprising a step of:
detecting a “W” shaped profile in a tangent plane distance value calculation and/or plot indicative of phase separation by the one or more processors.

20. The method of claim 16, further comprising a step of:
determine a Gibbs free energy value at a feed point for use in the tangent plane distance analysis.
